(19) United States
(12) Patent Application Publication
(10) Pub. No.: US 2022/0173632 A1
(43) Pub. Date: Jun. 2, 2022

(54) Micro Water Pump and Electronic Device Using Same

(71) Applicant: AAC Microtech (Changzhou) Co., Ltd., Changzhou City (CN)

(72) Inventors: Detao Xu, Shenzhen (CN); Fanghua Ling, Shenzhen (CN)

(21) Appl. No.: 17/533,153

(22) Filed: Nov. 23, 2021

(30) Foreign Application Priority Data
Nov. 27, 2020 (CN) 202011358611.5

(51) Int. Cl. H02K 5/20; F04D 13/06; F04D 29/08; F04D 29/42; F04D 29/58; H02K 9/193; H02K 11/33; H02K 21/22

(52) U.S. Cl. CPC H02K 5/203; F04D 13/06; F04D 29/086; F04D 29/426; H02K 2211/03; H02K 9/193; H02K 11/33; H02K 21/22; F04D 29/588

(57) ABSTRACT

The present invention provides a micro water pump includes a pump body provided with an inner cavity, an inlet, and an outlet; a drive mechanism installed on the pump body for driving liquid from the inlet into the inner cavity and to discharge from the outlet. The pump body includes a base, an upper cover, and a sealing ring sandwiched between the base and the upper cover. One of the base and the upper cover is provided with a first circular groove surrounding the inner cavity for embedding the sealing ring. The first circular groove includes a bottom wall facing the base or the upper cover.

### FIELD OF THE PRESENT DISCLOSURE

The present disclosure relates to fluid machinery, in particular to a micro water pump.

### DESCRIPTION OF RELATED ART

A sealing ring is usually sandwiched between a base and an upper cover of a pump body to achieve sealing. The sealing ring between the base and the upper cover of the existing water pump has poor sealing effect and is prone to leakage problems.

Therefore, it is necessary to study a new type of micro water pump to solve the above problems.

### SUMMARY OF THE PRESENT INVENTION

One of the objects of the present invention is to provide a micro water pump with improved heat-dissipation performance.

To achieve the above-mentioned objects, the present invention provides a micro water pump, comprising: a pump body provided with an inner cavity, an inlet communicating with the inner cavity, and an outlet communicating with the inner cavity; a drive mechanism installed on the pump body for driving liquid from the inlet into the inner cavity and discharge from the outlet. The pump body comprises a base, an upper cover, and a sealing ring sandwiched between the base and the upper cover; one of the base and the upper cover is provided with a first circular groove surrounding the inner cavity for embedding the sealing ring. The first circular groove comprises a bottom wall facing the base or the upper cover; and at least two first circular bumps protrudes from one side of the sealing ring facing the bottom wall of the groove, and at least one second circular bump protrudes on a side of the sealing ring opposite to the first circular bump.

Further, the other of the base and the upper cover is provided with a second circular groove opposite to the first circular groove, and the second circular bump is embedded in the second circular groove.

Further, a cross-sectional profile of the first circular bump gradually shrinks in a direction away the bottom wall of the groove; and/or, a cross-sectional profile of the second circular bump gradually shrinks in a direction away from the bottom wall of the groove.

Further, the micro water pump comprises a rotating shaft mounted with the base or upper cover, wherein the drive mechanism comprises an impeller arranged in the inner cavity for being rotatably connected with the rotating shaft, a rotor installed on the impeller, and a stator in the base for driving the rotor to rotate.

Further, the impeller comprises a circular part, an installation part located inside the circular part and rotationally connected with the rotating shaft, and a blade located on an outer sidewall of the circular part; the rotor is a circular magnet installed in the circular part or the installation part.

Further, the rotor is fixed to an inner sidewall of the circular part or the outer sidewall of the installation part by gluing.

Further, a third circular groove is provided on the side of the base opposite to the upper cover, and the stator is embedded in the third circular groove.

Further, the micro water pump comprises a circuit board installed on the base and electrically connected to the stator via a cable.

Further, a side of the base back to the upper cover includes an installation slot for embedding the circuit board therein.

Further, a side of the base back to the upper cover defines a cable groove communicating with the third circular groove and the installation slot, for accommodating the cable.

Further, one of the base and the upper cover includes a positioning column, and the other of the base and the upper cover includes a positioning hole engaging with the positioning column for positioning the base and the upper cover.

The present invention further provides an electronic device comprising a liquid-cooled heat dissipation system, having a micro water pump as described above.

### BRIEF DESCRIPTION OF THE DRAWINGS

Many aspects of the exemplary embodiments can be better understood with reference to the following drawings. The components in the drawing are not necessarily drawn to scale, the emphasis instead being placed upon clearly illustrating the principles of the present disclosure.

FIG. 1 is an illustrative isometric view of a micro water pump in accordance with an exemplary embodiment of the present invention;

FIG. 2 is also an illustrative isometric view of a micro water pump in FIG. 1, but from another aspect;

FIG. 3 is a cross-sectional view of the micro water pump in FIG. 1, taken along line AA;

FIG. 4 is an exploded and cross-sectional view of the micro water pump;

FIG. 5 is an exploded and isometric view of the micro water pump;

FIG. 6 is similar to FIG. 5, from another aspect;

FIG. 7 is an isometric view of a rotating shaft of the micro water pump;

FIG. 8 is a cross-sectional view of a micro water pump in accordance with another exemplary embodiment of the present invention;

FIG. 9 is a structural diagram of an electronic device incorporating the micro water pump.

### DETAILED DESCRIPTION OF THE EXEMPLARY EMBODIMENTS

The present disclosure will hereinafter be described in detail with reference to exemplary embodiments. To make the technical problems to be solved, technical solutions and beneficial effects of the present disclosure more apparent, the present disclosure is described in further detail together with the figures and the embodiments. It should be understood the specific embodiments described hereby is only to explain the disclosure, not intended to limit the disclosure.

It should be noted that all directional indicators (such as up, down, left, right, front, back, inside, outside, top, bottom . . . ) in the embodiments of the present invention are only used to explain that they are in a specific posture (As shown in the Fig. below), the relative positional relationship between the components, etc., if the specific posture changes, the directional indication will also change accordingly.

It should also be noted that when an element is referred to as being “fixed on” or “arranged on” another element, the element may be directly on the other element or there may be a centering element at the same time. When an element is referred to as being “connected” to another element, it can be directly connected to the other element or an intermediate element may be present at the same time.

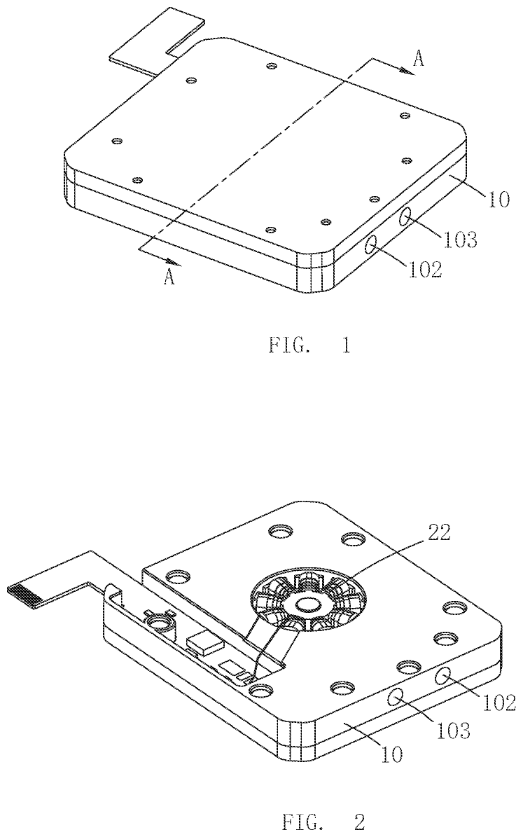

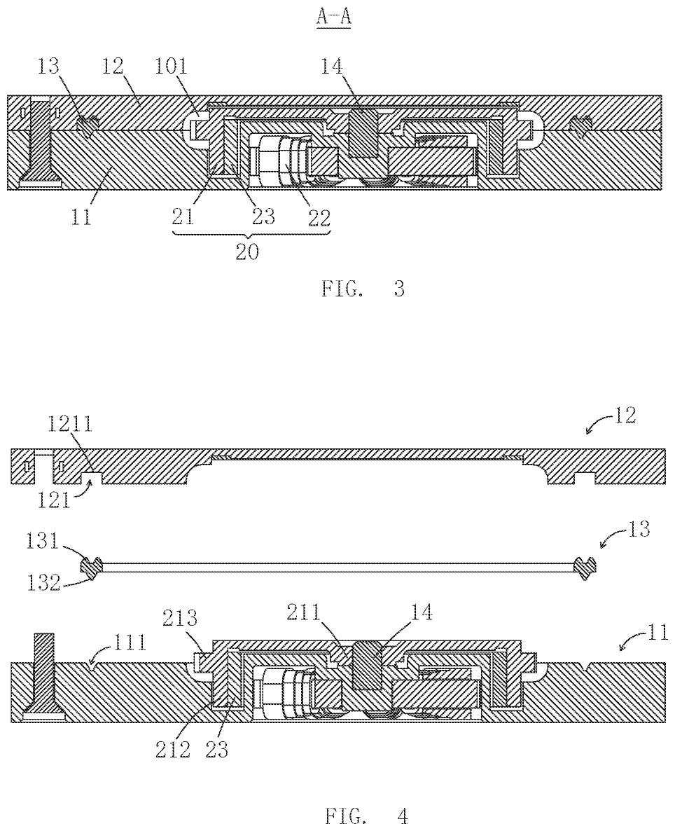

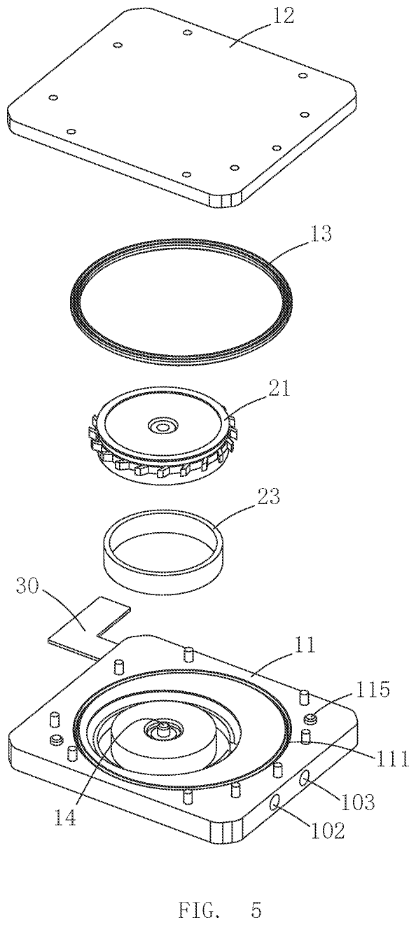

As shown in FIGS. 1-4, an embodiment of the present invention provides a micro water pump comprising a pump body 10 and a drive mechanism 20. The pump body 10 is provided with an inner cavity 101, an inlet 102 connected to the inner cavity 101, and an outlet 103 connected to the inner cavity 101. The drive mechanism 20 is installed in the pump body 10 to drive liquid from the inlet 102 into the inner cavity 101 and discharged from the outlet 103.

The pump body 10 comprises a base 11, an upper cover 12 and a sealing ring 13. The upper cover 12 is provided with a first circular groove 121 surrounding the inner cavity 101. The sealing ring 13 is sandwiched between the base 11 and the upper cover 12 and partially embedded in the first circular groove 121. The first circular groove 121 comprises a bottom wall of the groove 1211 facing the base 11. At least two first circular bumps 131 are protrudingly provided on the side of the sealing ring 13 facing the bottom wall of the groove 1211. At least one second circular bump 132 is protruded on the side of the sealing ring 13 with its back facing the first circular bump 131. When the upper cover 12 is connected to the base 11, the upper cover 12 squeezes the first circular bump 131 and the base 11 squeezes the second circular bump 132 to form sealing between the upper cover 12 and the base 11.

The liquid in the inner cavity 101 is prevented from leaking out from the gap between the upper cover 12 and the base 11.

In this embodiment, at least two first circular bumps 131 are protrudingly provided on the side the sealing ring 13 facing the bottom wall of the groove 1211. At least one second circular bump 132 is protruded on the side of the sealing ring 13 with its back facing the first circular bump 131. The sealing ring 13 of this embodiment can get more compression and achieve a better sealing effect. At least two first circular bumps 131 can form double to multiple sealings, and the sealing effect is good. In addition, the arrangement of the first circular bump 131 and the second circular bump 132 can extend the water flow channel, increase the resistance of the liquid in the inner cavity 101 to leak out, and achieve a better sealing effect.

Exemplarily, the cross-sectional profile of the first circular groove 121 is rectangular, and the bottom wall of the groove 1211 is flat plane.

It should be noted that the first circular groove 121 is not limited to being provided on the upper cover 12, and the first circular groove 121 is also possible to be provided on the base 11. When the first circular groove 121 is set on the base 11, the bottom wall of the groove 1211 faces the upper cover 12.

Illustratively, the number of the first circular bump 131 is two, and the number of the second circular bump 132 is one. The apex of the second circular bump 132 is located between the apexes of the two first circular bumps 131, and the sealing ring 13 forms a three-pointed sealing structure.

Optionally, the base 11 is provided with a second circular groove 111 opposite to the first circular groove 121. The second circular bump 132 is embedded in the second circular groove 111. In some embodiments, the base 11 may not be provided with the second circular groove 111.

It can be seen from the above description that the first circular groove 121 may be provided on the base 11, and in this embodiment, the second circular groove 111 is correspondingly provided on the upper cover 12.

The cross-sectional profile of the first circular bump 131 gradually shrinks toward the bottom wall of the groove 1211. Illustratively, the cross-sectional profile of the first circular bump 131 is V-shaped.

The cross-sectional profile of the second circular bump 132 gradually shrinks away from the bottom wall of the groove 1211. Illustratively, the cross-sectional profile of the second circular bump 132 is V-shaped.

Optionally, the cross-sectional profile of the second circular groove 111 is V-shaped, which is compatible with the shape of the second circular bump 132.

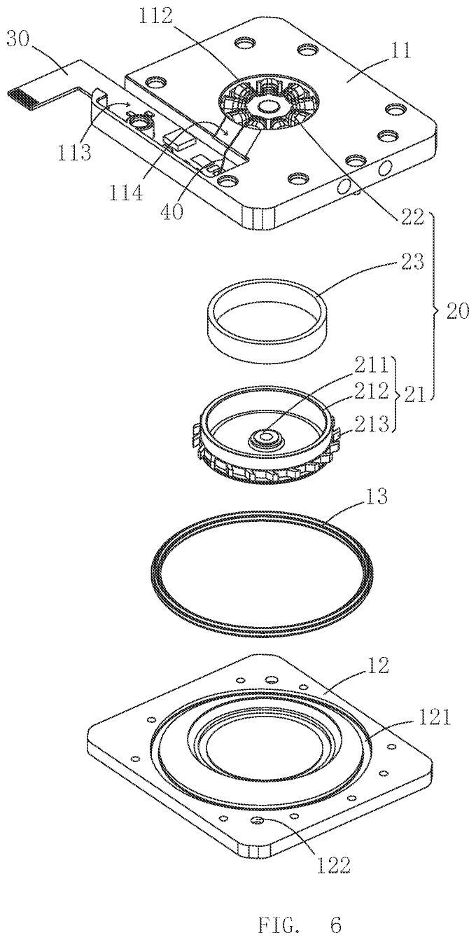

As shown in FIGS. 3-6, the drive mechanism 20 comprises an impeller 21, a stator 22, and a rotor 23. The impeller 21 is located in the inner cavity 101. The base 11 is provided with a rotating shaft 14. The impeller 21 is connected to the rotating shaft 14 in rotation. The rotor 23 is installed on the impeller 21. The stator 22 is installed in base 11. The stator 22 is used to drive the rotor 23 to rotate.

During operation, alternating current is applied to the stator 22, and according to the principle of electromagnetic induction, the stator 22 generates rotating magnetic field. The rotor 23 is rotated by the ampere force in the rotating magnetic field, and the rotating rotor 23 drives the impeller 21 to rotate. The liquid enters the inner cavity 101 from the inlet 102, rotates at a high speed under the impeller 21 and performs centrifugal movement. When the liquid reaches the outlet 103, it is thrown out from the outlet 103. After the liquid is thrown out, the pressure in the inner cavity 101 decreases, which is much lower than the atmospheric pressure. The external fluid is replenished from the inlet 102 into the inner cavity 101 under the action of the atmospheric pressure, and the above-mentioned actions are repeatedly implemented to realize the delivery of the liquid.

Since the stator 22 and the rotor 23 interact through electromagnetic force, they do not need to be directly connected. Therefore, it is not needed to open a mounting hole communicating with the inner cavity 101, which can prevent the fluid in the inner cavity 101 from leaking through the mounting hole.

Of course, it is also possible to install a motor on the pump body 10, and the output shaft of the motor extends into the inner cavity 101 to be connected to the impeller 21. The motor drives the impeller 21 to rotate through the output shaft.

The rotating shaft 14 is not limited to being provided in the base 11, and the rotating shaft 14 can also be provided in the upper cover 12.

Optionally, the rotating shaft 14 is molded on the base 11 by over-injection molding. In this embodiment, the connection between the rotating shaft 14 and the base 11 is firm, and the rotating operation of the impeller 21 is stable.

The impeller 21 comprises an installation part 211, a circular part 212 and a blade 213. The installation part 211 is located inside the circular part 212. The installation part 211 is connected to the rotating shaft 14 in rotation. The blade 213 is located on the outer sidewall of the circular part 212. The rotor 23 is a circular magnet installed in the circular part 212. Optionally, the rotor 23 is fixed to the inner sidewall of the circular part 212 by gluing.

Of course, the rotor 23 is not limited to being fixed to the inner sidewall of the circular part 212 by gluing. For example, the rotor 23 can also be embedded in the circular part 212 by over-injection.

The side of the base 11 with its back facing the upper cover 12 is provided with a third circular groove 112, and the stator 22 is embedded in the third circular groove 112. A third circular groove 112 is provided to accommodate the stator 22. The stator 22 does not increase the overall thickness of the pump body 10, so that the size of the pump body 10 is small.

The micro water pump also comprises a circuit board 30 installed in the base 11, and the circuit board 30 is electrically connected to the stator 22 through a cable 40. An installation slot 113 is provided on the side of base 11 with its back facing the upper cover 12. The circuit board 30 is embedded in the installation slot 113. In this embodiment, the circuit board 30 is accommodated in the installation slot 113 and is not exposed. It can avoid the components on the circuit board 30 from being bumped and damaged in the subsequent installation process. Moreover, the circuit board 30 is accommodated in the installation slot 113, and the circuit board 30 does not increase the overall thickness of the pump body 10, so that the size of the pump body 10 is small. Of course, base 11 may not be provided with the installation slot 113. The circuit board 30 is directly installed on the outer surface of the base 11.

A cable groove 114 is provided on the side of the base 11 with its back facing the upper cover 12. The cable groove 114 is connected with the third circular groove 112 and the installation slot 113. The cable 40 is arranged in the cable groove 114. In this embodiment, the cable 40 is wired in the cable groove 114 and is not exposed, which can prevent the cable 40 from being pulled by an external force and breaking. Moreover, the cable 40 is wired in the cable groove 114, and the cable 40 does not increase the overall thickness of the pump body 10, so that the size of the pump body 10 is small. Of course, the base 11 may not be provided with the cable groove 114, and the cable 40 is directly wired on the outer surface of the base 11.

Optionally, base 11 is provided with a positioning column 115. A positioning hole 122 is provided in the upper cover 12. The positioning column 115 is embedded in the positioning hole 122 to form the positioning of the base 11 and the upper cover 12. Of course, the positions of the positioning column 115 and the positioning hole 122 can be interchanged. That is, the positioning column 115 may be provided in the upper cover 12, and the positioning hole 122 may be provided in the base 11. By setting the positioning column 115 and the positioning hole 122 to realize the positioning of the base 11 and the upper cover 12, the assembly accuracy between the base 11 and the upper cover 12 can be improved.

As shown in FIG. 7, optionally, the outer sidewall at the end connecting the rotating shaft 14 and the base 11 is provided with a concave part 141. When the concave part 141 is used for injection molding of the rotating shaft 14 and the base 11, the base 11 can be partially embedded in the concave part 141 so that the connection between the rotating shaft 14 and the base 11 becomes stronger. Illustratively, multiple concave parts 141 are arranged, and the multiple concave parts 141 are arranged around the axis of the rotating shaft 14 at intervals.

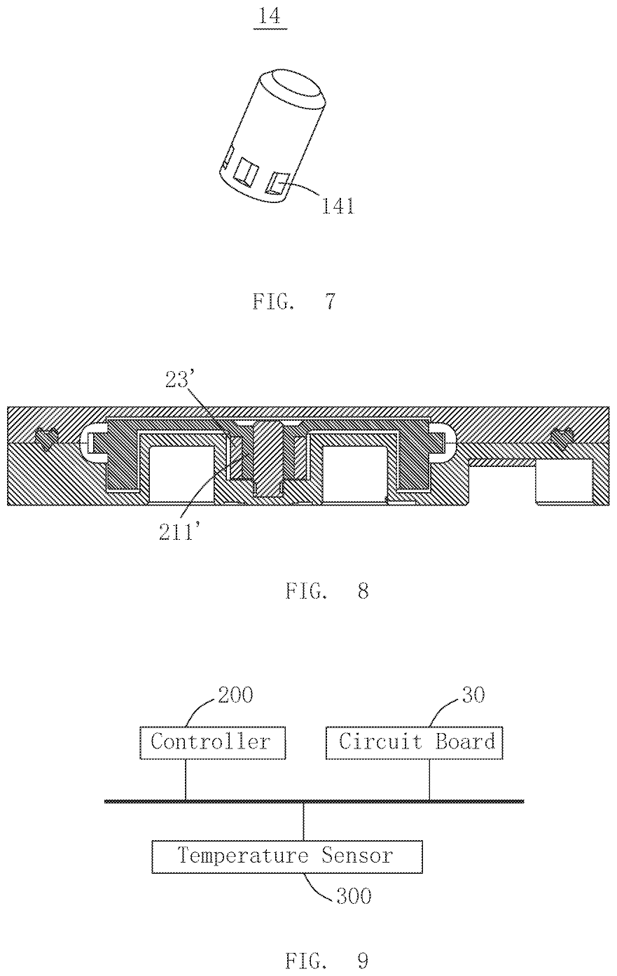

As shown in FIG. 8, as for the micro water pump proposed in another embodiment of the present invention, the difference between the micro water pump proposed in this embodiment and the micro water pump proposed in the above embodiments lies in: In this embodiment, the rotor 23′ is installed in the installation part 211′.

Optionally, the rotor 23′ is fixed to the outer sidewall of the installation part 211′ by gluing. Of course, the rotor 23′ can also be embedded in the installation part 211′ by over-injection. For other components and connection relationships of the micro water pump proposed in this embodiment, reference may be made to the above-mentioned embodiment, which will not be repeated here.

As shown in FIG. 9, an embodiment of the present invention also provides an electronic device, comprising a liquid-cooled heat dissipation system, and the liquid-cooled heat dissipation system comprises the above-mentioned micro water pump, which is used to transport cooling liquid.

The electronic device also comprises a controller 200 and a temperature sensor 300. The temperature sensor 300 and the circuit board 30 are electrically connected to the controller 200. The temperature sensor 300 is installed on objects that require heat dissipation. The temperature sensor 300 is used to detect the temperature of the object that needs to be dissipated, and transmit the detected temperature value to the controller 200. The controller 200 controls the circuit board 30 to adjust the pulse width of the input stator 22 according to the data detected by the temperature sensor 300. Thus, the speed of the impeller 21 is adjusted to change the flow rate of the cooling liquid, so as to achieve a better heat dissipation effect.

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms where the appended s claims are expressed.

What is claimed is:

1. A micro water pump, comprising:
a pump body provided with an inner cavity, an inlet communicating with the inner cavity, and an outlet communicating with the inner cavity;
a drive mechanism installed on the pump body for driving liquid from the inlet into the inner cavity and to discharge from the outlet; wherein
the pump body comprises a base, an upper cover, and a sealing ring sandwiched between the base and the upper cover; one of the base and the upper cover is provided with a first circular groove surrounding the inner cavity for embedding the sealing ring;
the first circular groove comprises a bottom wall facing the base or the upper cover; and
at least two first circular bumps protrudes from one side of the sealing ring facing the bottom wall of the groove, and at least one second circular bump protrudes on a side of the sealing ring opposite to the first circular bump.

2. The micro water pump as described in claim 1, wherein the other of the base and the upper cover is provided with a second circular groove opposite to the first circular groove, and the second circular bump is embedded in the second circular groove.

3. The micro water pump as described in claim 2, wherein a cross-sectional profile of the first circular bump gradually shrinks in a direction away the bottom wall of the groove; and/or,
a cross-sectional profile of the second circular bump gradually shrinks in a direction away from the bottom wall of the groove.

4. The micro water pump as described in claim 1 further comprising a rotating shaft mounted with the base or upper cover, wherein the drive s mechanism comprises an impeller arranged in the inner cavity for being rotatably connected with the rotating shaft, a rotor installed on the impeller, and a stator in the base for driving the rotor to rotate.

5. The micro water pump as described in claim 4, wherein the impeller comprises a circular part, an installation part located inside the circular part and rotationally connected with the rotating shaft, and a blade located on an outer sidewall of the circular part; the rotor is a circular magnet installed in the circular part or the installation part.

6. The micro water pump as described in claim 5, wherein the rotor is fixed to an inner sidewall of the circular part or the outer sidewall of the installation part by gluing.

7. The micro water pump as described in claim 4, wherein a third circular groove is provided on the side of the base opposite to the upper cover, and the stator is embedded in the third circular groove.

8. The micro water pump as described in claim 7 further comprising a circuit board installed on the base and electrically connected to the stator via a cable.

9. The micro water pump as described in claim 8, wherein a side of the base back to the upper cover includes an installation slot for embedding the circuit board therein.

10. The micro water pump as described in claim 9, wherein a side of the base back to the upper cover is provided with a cable groove communicating with the third circular groove and the installation slot, for accommodating the cable. s 11. The micro water pump as described in claim 1, wherein, one of the base and the upper cover includes a positioning column, and the other of the base and the upper cover includes a positioning hole engaging with the positioning column for positioning the base and the upper cover.

12. An electronic device comprising a liquid-cooled heat dissipation system, having a micro water pump as described in claim 1.
